(19) United States
(12) Patent Application Publication
(10) Pub. No.: US 2013/0293930 A1
(43) Pub. Date: Nov. 7, 2013

(54) IMAGE FORMING APPARATUS, IMAGE FORMING PROGRAM, AND IMAGE PROCESSING METHOD

(71) Applicant: CANON KABUSHIKI KAISHA, Tokyo (JP)

(72) Inventors: Go Araki, Suntou-gun (JP); Yuuji Takayama, Yokohama-shi (JP); Tomoyuki Saiki, Suntou-gun (JP); Hikaru Uchidate, Yokohama-shi (JP)

(21) Appl. No.: 13/875,682

(22) Filed: May 2, 2013

(30) Foreign Application Priority Data
May 7, 2012 (JP) 2012-105896

(51) Int. Cl. H04N 1/00

(52) U.S. Cl. CPC H04N 1/00278
USPC 358/3.24

(57) ABSTRACT

In an image forming apparatus, an image of a document is read as document image data, and an image processing method of image data to be overwritten on the document is switched based on the read document image data.

### BACKGROUND

1. Technical Field

Aspects of the present invention relate to an image forming apparatus having multiple functions including a function of reading a document and a function of forming an image on a recording material. The image forming apparatus includes a copying machine, a laser beam printer, a facsimile machine, or the like.

2. Description of the Related Art

Conventionally, in an image forming apparatus including a document reading apparatus, a document conveyance path and a conveyance apparatus for reading a document and a recoding material conveyance path and an apparatus for forming an image on a recording material are arranged independently from each other. Such arrangements have always caused increases in structural complication, cost, and size of the apparatus. Japanese Patent Application Laid-Open No. 2000-185881 discusses an image forming apparatus to deal with such issues. The image forming apparatus includes a document reading unit in a middle of a recording material conveyance path extending from a sheet feeding unit to a sheet discharge unit, so that a document conveyance path and the recording material conveyance path are shared. Such an arrangement enables simplification of structure and reduction of size and cost of the image forming apparatus.

Meanwhile, Japanese Patent Application Laid-Open No. 10-129071 discusses a technique for overwriting print. According to the technique, an image printed on a document is read, and an overwriting image is generated based on the read image. Then, the overwriting image is printed on the document in an overwriting manner. If a document conveyance path and a recording material conveyance path are shared, a document after document reading can be used as a recording material, so that the overwriting printing as discussed in Japanese Patent Application Laid-Open No. 10-129071 can be readily performed.

In general, an image forming apparatus employs a method for expressing gradations of an image by performing halftone image processing such as amplitude modulation (AM) screen processing and frequency modulation (FM) screen processing for halftone reproduction. For example, in an image forming apparatus employing an electrophotographic method, the AM screen processing is suitable for an area having lesser high-frequency components of an image. Thus, gradations are often expressed by adjusting a dot size by the AM screen processing. The FM screen processing uses frequency modulation to express gradations, and the FM screen processing forms a random dot pattern unlike a periodic dot pattern arranged by the AM screen processing. Herein, dither processing and error diffusion processing are described as examples of the AM screen processing and the FM screen processing, respectively.

In a case that an image is formed by overwriting on an image already formed on a document and the document image is generated by the AM screen, there is a case where interference fringes (herein below referred to as a moire) occur on the image due to interference between an AM screen period on the document and a period of the AM screen image to be formed by overwriting.

### SUMMARY

According to an aspect of the present invention, an image forming apparatus includes a reading unit configured to read an image of a document, and a control unit configured to switch image processing with respect to an overwriting image to overwrite the document based on the read image of the document, wherein the control unit switches image processing of the overwriting image to image processing different from image processing with respect to the image of the document.

According to another aspect of the present invention, a method for image processing of an image forming apparatus includes overwriting an image on a document on which an image is recorded, and performing image processing different from image processing with respect to the recorded image on the document in a case where image processing is performed on the overwriting image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating an image forming apparatus.

FIG. 2 illustrates a process performed when images are formed on two sides of a recording material.

FIGS. 3A through 3E illustrate a series of operations for reading images of two sides of a document.

FIG. 4 is a control block diagram of the image forming apparatus.

FIG. 5 is a circuit block diagram of a document reading unit.

FIGS. 6A through 6D illustrate a series of operations performed when overwriting printing is performed on one side of a document.

FIGS. 7A through 7G illustrate a series of operations performed when overwriting printing is performed on two sides of a document.

FIGS. 8A, 8B, and 8C illustrate examples of a document, an overwriting image, and an overwritten image printed on the document, respectively.

FIG. 9 is a functional block diagram of an image processing apparatus according to a first exemplary embodiment.

FIG. 10 is a flowchart illustrating an image processing operation of the image processing apparatus according to the first exemplary embodiment.

FIGS. 11A, 11B, and 11C illustrate examples of a document, an overwriting image, and an overwritten image printed on the document, respectively.

FIG. 12 is a functional block diagram of an image processing apparatus according to a second exemplary embodiment.

FIG. 13 is a flowchart illustrating an image processing operation of the image processing apparatus according to the second exemplary embodiment.

FIGS. 14A, 14B, and 14C illustrate examples of a document, an overwriting image, and an overwritten image printed on the document, respectively.

FIG. 15 is a functional block diagram of an image processing apparatus according to a third exemplary embodiment.

FIG. 16 is a flowchart illustrating an image processing operation of the image processing apparatus according to the third exemplary embodiment.

### DESCRIPTION OF THE EMBODIMENTS

Various exemplary embodiments, features, and aspects of the invention will be described in detail below with reference to the drawings.

### [Configuration of Image Forming Apparatus and One-Sided Image Forming Operation]

A configuration and an operation of an image forming apparatus with a document reading function (hereinbelow referred to as an image forming apparatus) according to a first exemplary embodiment are described. First, an image forming operation performed on one side of a recording material is described.

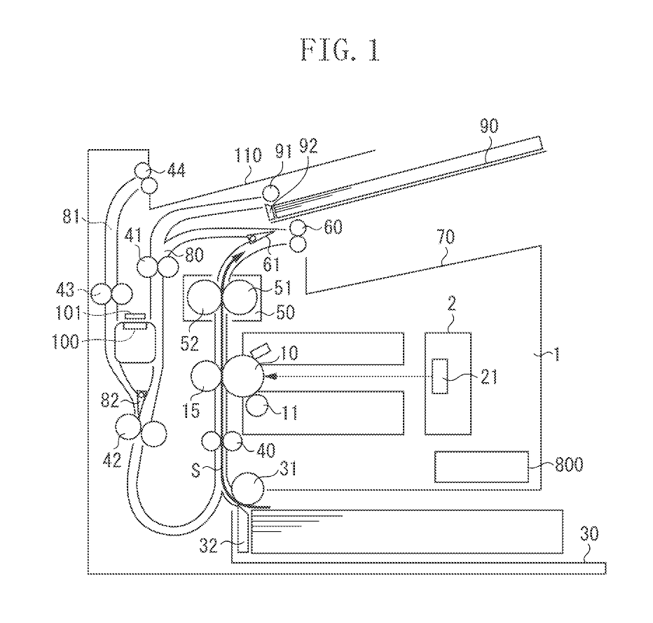

FIG. 1 is a schematic diagram illustrating an image forming apparatus 1. The image forming apparatus 1 includes a rotatable photosensitive drum 10 serving as an image bearing member, and a developing roller 11 arranged next to the photosensitive drum 10. The developing roller 11 rotates while retaining toner thereon, and supplying the toner to the photosensitive drum 10. When the image forming apparatus 1 receives a print instruction from an external computer, a light emitting unit 21 disposed in an exposure unit 2 emits a laser light to a surface of the rotating photosensitive drum 10. The exposure unit 2 includes members such as a polygon mirror used to scan the laser light and a motor for rotating the polygon mirror, which are not illustrated. When the surface of the photosensitive drum 10 is irradiated with the laser light, a latent image is formed. With the rotation of the developing roller 11, the toner retained on the developing roller 11 is supplied to the latent image formed on the surface of the photosensitive drum 10, so that a toner image is formed on the surface of the photosensitive drum 10.

Recording materials S stored in a first sheet feeding unit 30 are conveyed one by one toward conveyance rollers 40 by a pick-up roller 31 and a recording material separation unit 32. The conveyance rollers 40 convey the recording material S toward a transfer unit 15 such that the toner image developed on the surface of the photosensitive drum 10 is transferred to a predetermined position of the recording material. The toner image conveyed to the transfer unit 15 with rotation of the photosensitive drum 10 is transferred to the recording material S by a high voltage (hereinbelow also referred to as a transfer bias) applied to the transfer unit 15 and a pressing force applied from the transfer unit 15 to the photosensitive drum 10. Moreover, the recording material S is conveyed to a fixing unit 50 by the transfer unit 15 and the photosensitive drum 10. The fixing unit 50 includes a heating roller 51 and a pressing roller 52 which are rotatable. In the fixing unit 50, the toner image is fixed onto the recording material S by heat from the heating roller 51 and pressing force from the pressing roller 52. The recording material S with the fixed toner image is conveyed by discharge rollers 60. In a case of one-sided printing, the discharge rollers 60 simply convey the recording material S to the outside, and the recording material S is discharged and stacked on a first sheet stacking unit 70.

### [Two-Sided Image Forming Operation]

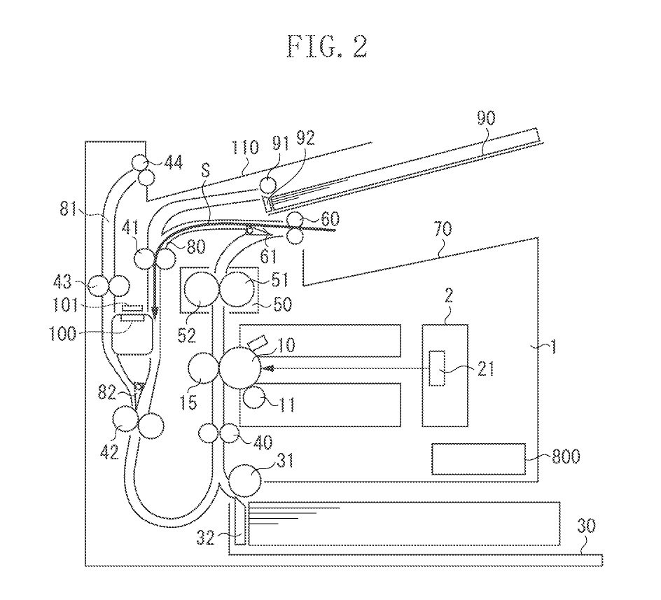

Next, an operation for forming images on two sides of a recording material is described. Since an image forming operation to be performed on one side of a recording material is similar to that described with reference to FIG. 1, a description thereof is omitted. FIG. 2 illustrates a part of a process performed when images are formed on two sides of a recording material S. After an image is formed on one side of the recording material S as described with reference to FIG. 1, the recording material S is reversed for formation of an image on another side of the recording material S. A two-sided flapper 61 switches a conveyance path to a position illustrated in FIG. 2 after a trailing edge of the recording material S passes through a position of the two-sided flapper 61. Then, the discharge rollers 60 are rotated in a direction opposite to that for discharging a sheet to the first sheet stacking unit 70, so that the recording material S is conveyed to a two-sided conveyance path 80. The reversely conveyed recording material S is conveyed to a document reading unit 100 via conveyance rollers 41. Subsequently, the recording material S is conveyed by conveyance rollers 42 and 40, and then conveyed to the transfer unit 15 again. In the transfer unit 15, a toner image is transferred to the recording material S by a process similar to that described with reference to FIG. 1. After undergoing the process in the fixing unit 50, the recording material S is discharged and stacked on the first sheet stacking unit 70.

### [Operation for Concurrently Executing a Two-Sided Document Reading Operation and a Two-Sided Image Forming Operation]

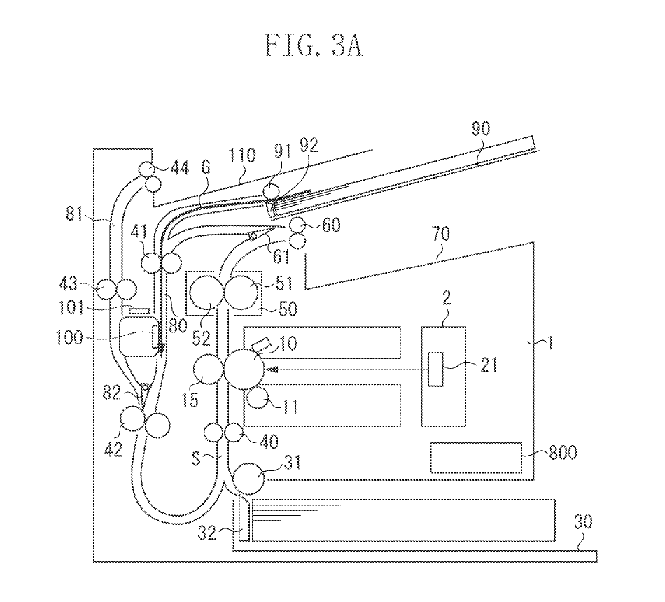

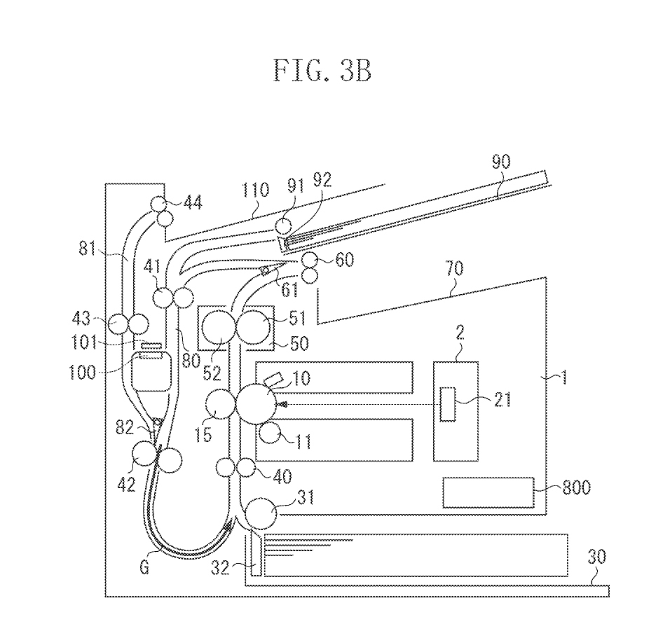

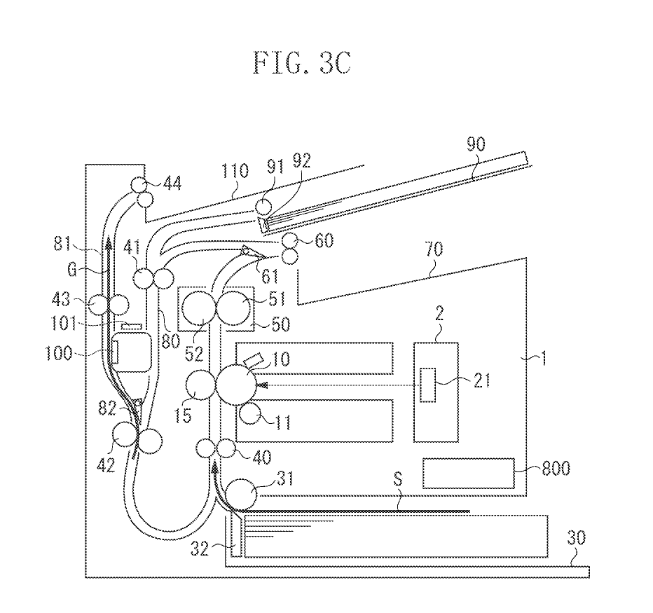

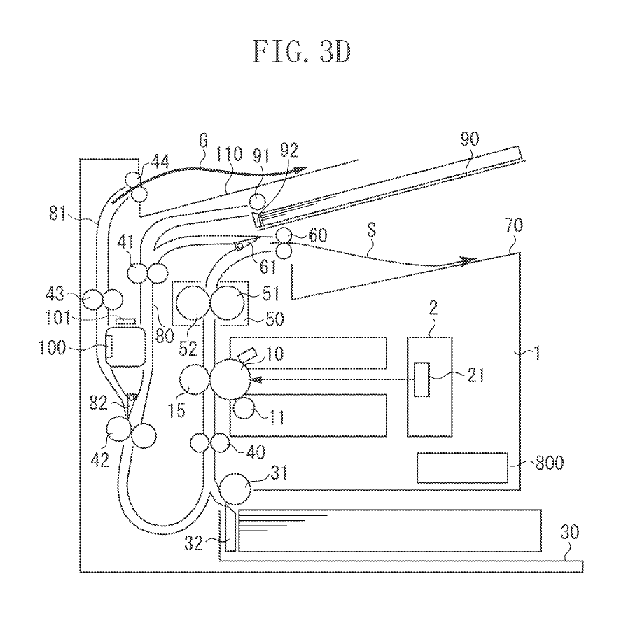

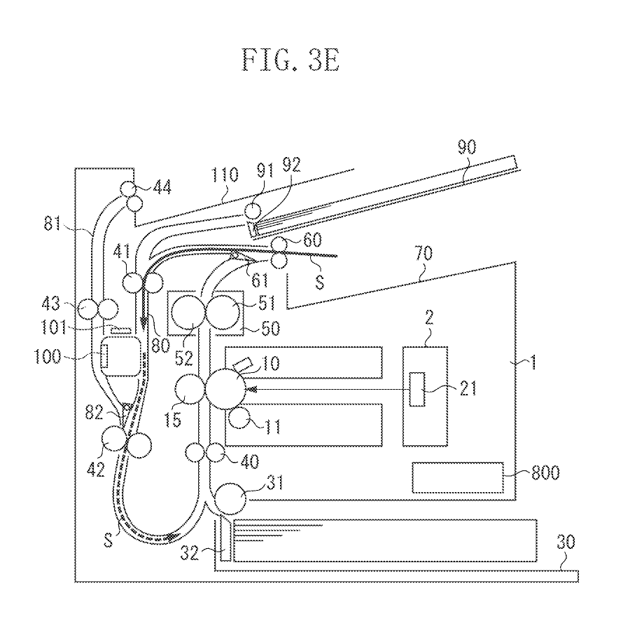

Referring to FIGS. 3A through 3E, concurrent operations for reading images on both sides of a document and image formation on both sides a recording material are described. FIG. 3A illustrates a state in which reading of a front surface of a document is started. Documents G stored in a second sheet feeding unit 90 are conveyed one by one toward the conveyance rollers 41 by a pick-up roller 91 and a recording material separation unit 92. The pick-up roller 91 picks up the document G stored in the second sheet feeding unit 90. On the other hand, the document reading unit 100 includes a light emitting diode (LED) serving as a light emitting unit for emitting light to a document, and a contact image sensor (CIS) for reading an image of a document. Before a reading operation of a first side of the document G fed from the second sheet feeding unit 90 is started, the document reading unit 100 emits light to a white reference member 101 to read a reflected light from the white reference member 101 by the contact image sensor, and corrects a white reference value based on a result obtained by reading the reflected light. Then, the document reading unit 100 is rotated to a position facing the two-sided conveyance path 80 (a state illustrated in FIG. 3A) to read the document G conveyed to the two-sided conveyance path 80. The document G is conveyed to the document reading unit 100 by the conveyance rollers 41, and an image on the first side of the document G is read by the rotated document reading unit 100. The information read by the document reading unit 100 is stored in an image memory 804, described below, as first side image information of the document G. The white reference member 101 is disposed downward to prevent adhesion of dust thereto. According to the present exemplary embodiment, the white reference member 101 is used. However, color of the member can be other than white as long as color can serve as reference.

FIG. 3B illustrates a state in which reading of the first side serving as the front surface of the document G is finished. Upon passing the document reading unit 100, the document G is conveyed by the conveyance rollers 42. The conveyance rollers 42 stop when a trailing edge of the document G passes a switchback flapper 82. Therefore, the document G stops in a state of being pinched by the conveyance rollers 42. When the switchback flapper 82 is switched, a conveyance path for the document G is switched from the two-sided conveyance path 80 to a document-only conveyance path 81, and then the document G is conveyed toward the document-only conveyance path 81.

FIG. 3C illustrates a state in which a second side of the document G is read. The document reading unit 100 is rotated to a position facing the document-only conveyance path 81 at a timing synchronized with the switch of the conveyance path from the two-sided conveyance path 80 to the document-only conveyance path 81 by the switchback flapper 82. The conveyance rollers 42 rotate reversely, and the document G is conveyed along the document-only conveyance path 81 to the document reading unit 100. When the document G is conveyed and passes the document reading unit 100, image information of the second side of the document G is read, and the read image information is stored in the image memory 804 as second side information.

Herein, while the second side of the document G is being read, a recording material S is fed from the first sheet feeding unit 30 by the pick-up roller 31 and conveyed by the conveyance rollers 40. The light emitting unit 21 emits light to the photosensitive drum 10 based on the image information of the second side of the document G stored in the image memory 804 and forms an electrostatic latent image on the photosensitive drum 10 so that the image of the second side of the document G is formed on the recording material S. The electrostatic latent image is developed with toner, and a toner image is formed on the photosensitive drum 10. Subsequently, the toner image is transferred from the photosensitive drum 10 to the recording material S by the transfer unit 15, and the recording material S with the transferred toner image is conveyed to the fixing unit 50. In the fixing unit 50, the toner image is fixed to the recording material S, and image formation of the second side of the document is completed. In FIG. 3C, feeding of the recording material S is started in the course of reading the image information of the second side of the document. However, the recording material S can be fed after the image information of the second side of the document G is read.

FIG. 3D illustrates a state in which reading of a back surface of the document G is finished. When reading of the document G is finished, the document G is conveyed by conveyance rollers 43 and conveyance rollers 44, and stacked on a second sheet stacking unit 110. When a trailing edge of the document G passes the switchback flapper 82, the switchback flapper 82 is switched such that the recording material S is conveyed toward a direction of the conveyance rollers 40. Accordingly, the conveyance path is switched from the document-only conveyance path 81 to the two-sided conveyance path 80. The recording material S on which the image formation of the second side of the document is completed is reversed by rotating the discharge rollers 60 in a reverse direction, and conveyed toward the two-sided conveyance path 80 by switching the two-sided flapper 61.

FIG. 3E illustrates an image forming operation performed on the recording material S. The recording material S conveyed to the two-sided conveyance path 80 passes a position of the rotated document reading unit 100, and is conveyed to the conveyance rollers 40 via the conveyance rollers 42, so that the recording material S is again conveyed toward the transfer unit 15 as illustrated with a broken line in FIG. 3. Here, the image of the second side of the document is already formed on the recording material S. Thus, the image of the first side of the document is formed as an electrostatic latent image on the photosensitive drum 10 based on the image information of the first side of the document which has been stored in the image memory 804 beforehand. Then, the image of the first side of the document G is transferred and fixed to the recording material S by a process similar to that described with reference to FIG. 3C, and the recording material S is discharged and stacked on the sheet stacking unit 70.

### [Configuration of Image Forming Apparatus and Computer Control Unit]

FIG. 4 is a block diagram illustrating a computer 850 and an apparatus control unit 800 including a central processing unit (CPU) 801 serving as a control unit of the image forming apparatus 1. Operations of the CPU 801, an application specific integrated circuit (ASIC) 802, and the computer 850 during image forming operations according to the first exemplary embodiment are described with reference to FIG. 4.

In FIG. 4, the CPU 801 is connected to the light emitting unit 21 of the exposure unit 2 via the ASIC 802. The CPU 801 outputs a control signal to the ASIC 802 to cause the light emitting unit 21 to emit a laser beam so that a desired latent image is formed on the photosensitive drum 10 by scanning the laser beam. The exposure unit 2 irradiates the photosensitive drum 10 with the laser beam based on image data from an image processing apparatus 857 to form the latent image. Moreover, the CPU 801 controls operations of drive systems such as a main motor 830, a sheet feeding solenoid 822, and a two-sided drive motor 840. The main motor 830 drives the pick-up roller 31 and the conveyance rollers 40 for conveyance of a recording material S, the photosensitive drum 10, the transfer unit 15, the heating roller 51, and the pressing roller 52. The sheet feeding solenoid 822 is turned on to drive the pick-up roller 31 at the start of driving of a sheet feeding roller for feeding a recording material S. The two-sided drive motor 840 drives the document pick-up roller 91, and the conveyance rollers 41, 42, 43, and 44.

Further, the CPU 801 controls operations of a high-voltage power source 810 for outputting a charging voltage, a developing voltage, and a transfer voltage necessary to form an image, the fixing unit 50, and a low-voltage power source 811. Furthermore, the CPU 801 monitors temperature of the fixing unit 50 using a thermistor (not illustrated) disposed in the fixing unit 50, and controls the temperature of the fixing unit 50 to be maintained constant.

The CPU 801 is connected to a program memory 803 via a data communication bus (not illustrated), and the program memory 803 stores programs and data used to execute all or a part of processing performed by the CPU 801 for the above controls. The CPU 801 executes the operations described according to the present exemplary embodiment using the programs and data stored in the program memory 803.

The ASIC 802 controls speed of a motor of the exposure unit 2, the main motor 830, and the two-sided drive motor 840 based on an instruction of the CPU 801. In the motor speed control operation, the ASIC 802 detects a tack signal (a pulse signal that is output from a motor for each rotation thereof) from a motor, and outputs an acceleration signal or a deceleration signal to the motor by switching between these signals such that an interval of tack signals becomes a predetermined time. Accordingly, when such control is performed by a hardware circuit such as the ASIC 802, the CPU 801 has an advantage of reducing a control load thereof.

A CPU 851 executes an application and a printer driver stored in a program memory 853, and the computer 850 operates according to a user instruction received via an input/output apparatus 856. The computer 850 communicates with the CPU 801 of the apparatus control unit 800 via an external interface (IF) 852 and an external IF 805.

When a user issues an instruction to perform printing, the computer 850 generates image data to be printed in an image memory 854, and transmits a print command and the image data to the CPU 801. Upon receipt of the print command from the computer 850, the CPU 801 drives the main motor 830, the two-sided drive motor 840, and the sheet feeding solenoid 822 to convey a recording material S.

As described above, after a toner image formed on the photosensitive drum 10 is transferred to the recording material S by the transfer unit 15, the toner image is fixed to the recording material S by the fixing unit 50. Then, the recording material S is discharged to the first sheet stacking unit 70 as a recording material stacking unit by the discharge rollers 60. The CPU 801 supplies a predetermined power to the fixing unit 50 via the low-voltage power source 811 and generates a desired heat to heat the recording material S, so that the toner image is melted and fixed onto the recording material S.

When a user issues an instruction to read a document (also referred to as a scan instruction), the computer 850 transmits a scan command to the CPU 801. Then, the computer 850 receives read image data of a document G from the CPU 801 and stores the received image data in the image memory 854 or an external storage apparatus 855.

When a user instructs overwriting printing, the computer 850 transmits an overwriting printing command to the CPU 801. Then, the computer 850 receives read image data of a document G from the CPU 801 and stores the received image data in the image memory 854 or the external storage apparatus 855. The computer 850 generates overwriting image data while referring to the read image data of the document G, and stores the overwriting image data in the image memory 854 or the external storage apparatus 855. Subsequently, the computer 850 notifies the CPU 801 of completion of overwriting image data generation, and transmits the overwriting image data. Here, the overwriting printing instruction represents an instruction to overwrite an image on an image of a first side or a second side of the document G. Conveyance of the document G during the overwriting printing is described below.

Next, an operation of the control unit during a document reading operation according to the present exemplary embodiment is described. When the CPU 801 receives a scan command from the computer 850, the CPU 801 drives a two-sided flapper solenoid 820 and the two-sided drive motor 840 to operate the document feeding solenoid 823, so that a document G is conveyed by the document pick-up roller 91. The document reading unit 100 is connected to the ASIC 802 via various control signals such as a signal CISLED 903, a signal CISSTART 902, a clock SYSCLK 914, a signal S1_in 912, a signal S1_select 913, and a signal S1_out 910 which are described below. The CPU 801 stores document image data read from the document reading unit 100 via the ASIC 802 by various types of control into the image memory 804 connected to the ASIC 802. The CPU 801 transmits the stored document image data to the computer 850 via the external IF 805. Subsequently, the CPU 801 drives a switchback solenoid 821 to switch the switchback flapper 82 to the side of the document-only conveyance path 81, and reverses the two-sided drive motor 840 to convey the document G to the second sheet stacking unit 110.

### [Circuit Block Configuration of Document Reading Unit]

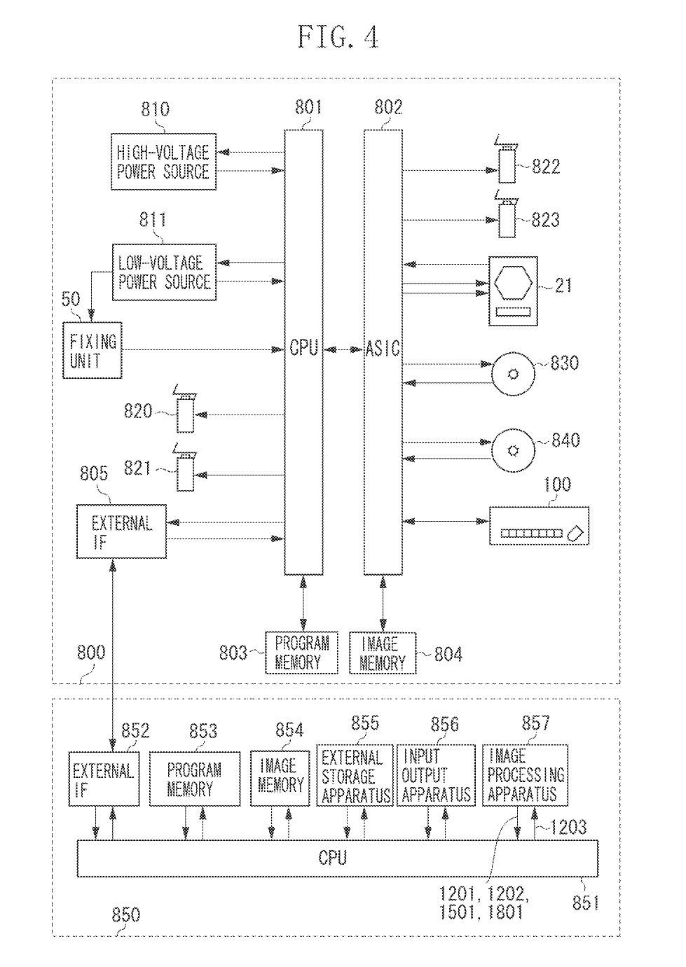

Referring to FIG. 5, a circuit block of the document reading unit 100 is described in detail. FIG. 5 is a circuit block diagram of a contact image sensor (CIS).

In FIG. 5, a CIS unit 901 includes, for example, photodiodes with 10368 pixels which are arranged in arrays with a specific main scanning density (1200 dots per inch (dpi) in this example). A start pulse signal CISSTART 902 and a transfer clock CISCLK 915 are supplied to the CIS. The system clock SYSCLK 914 is used to determine an operation speed of the CIS unit 901. The document reading unit 100 further includes an analog-to-digital (A/D) convertor 908, a timing generator 917, an output buffer 904, a shift register 905, a current amplification unit 906, and a light emitting element 907 for uniformly emitting light to a document G. A CIS sampling clock ADCLK 916 is used to determine a sampling speed of the A/D convertor 908. The light emitting element control signal CISLED 903 is supplied to the current amplification unit 906.

Next, an operation of the circuit block of the document reading unit 100 is described. When the signal CISSTART 902 is activated, the CIS unit 901 starts accumulating electric charge based on the received light, and sequentially sets data to the output buffer 904. Next, when the transfer clock CISCLK 915 (e.g., approximately 500 kHz to 1 MHz) is supplied, the data set in the output buffer 904 is transferred as a signal CISSNS 918 to the A/D convertor 908 by the shift register 905. Since the signal CISSNS 918 has a predetermined data assurance area, the signal CISSNS 918 needs to be sampled after a predetermined time elapses from a timing of a rising edge of the transfer clock CISCLK 915. Moreover, the signals CISSNS 918 are output by synchronizing with both rising and falling edges of the transfer clock CISCLK 915. Consequently, a frequency of the CIS sampling clock ADCLK 916 is generated to be twice as high as that of the transfer clock CISCLK 915, and the signal CISSNS 918 is sampled at the rising edge of the CIS sampling clock ADCLK 916. The timing generator 917 divides the system clock SYSCLK 914 to generate the CIS sampling clock ADCLK 916 and the transfer clock CISCLK 915. A phase of the CIS sampling clock ADCLK 916 is delayed by an amount of the data assurance area compared to the transfer clock CISCLK 915.

A signal CISSNS_D 919 generated by digitally converting the signal CISSNS 918 by the A/D convertor 908 is controlled by an output interface circuit 909 at a predetermined timing, and output as serial data of the signal S1_out 910. At that time, an analog output reference voltage is output from the start pulse signal CISSTART 902 to the signal CISSNS_D 919 with predetermined pixels, and the signal cannot be used as an effective pixel.

On the other hand, a control circuit 911 can variably control an A/D conversion gain of the A/D convertor 908 using the signal S1_in 912 and the signal S1_select 913. For example, if a contrast of a captured image is not obtained, the CPU 801 increases the contrast by increasing the A/D conversion gain of the A/D convertor 908, so that an image can be always captured with the suitable contrast.

According to the present exemplary embodiment, it is described that all of the pixels are output as one output signal CISSNS 918. However, pixels can be divided on an area basis, and a plurality of divided areas can be simultaneously converted by the A/D convertor 908 so that the pixels can be read faster. According to the present exemplary embodiment, the CIS is used as the document reading unit 100. Alternatively, a complementary metal-oxide-semiconductor (CMOS) sensor or a charge-coupled device (CCD) sensor may be used instead of the CIS.

[Document Conveyance State during Overwriting Printing Operation]

### (One-Sided Overwriting Printing Operation)

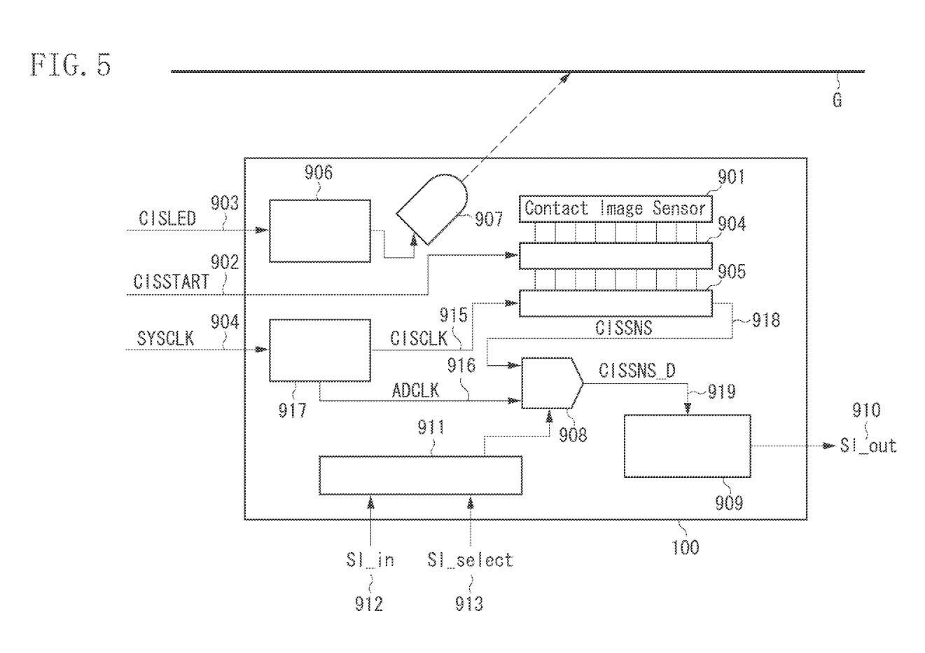

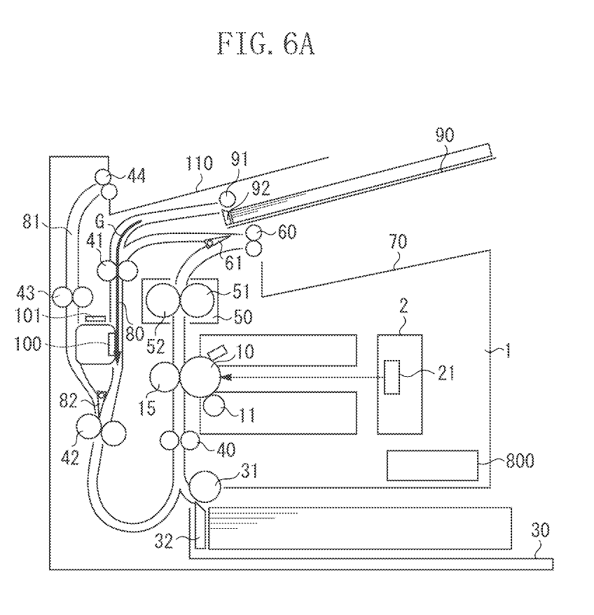

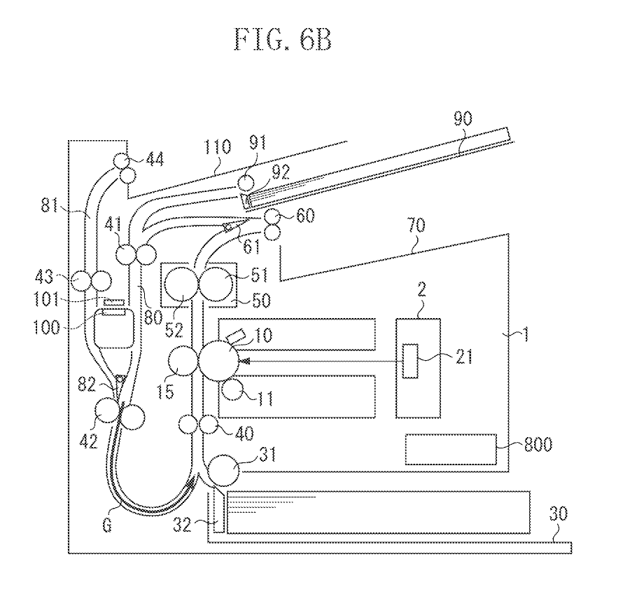

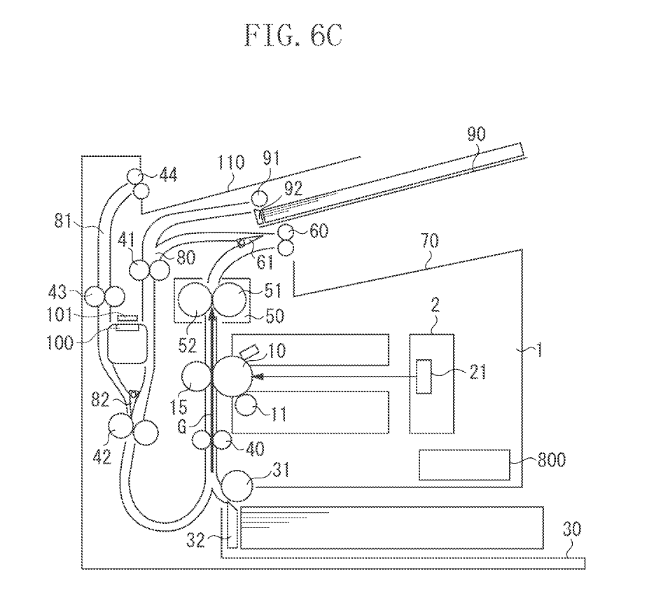

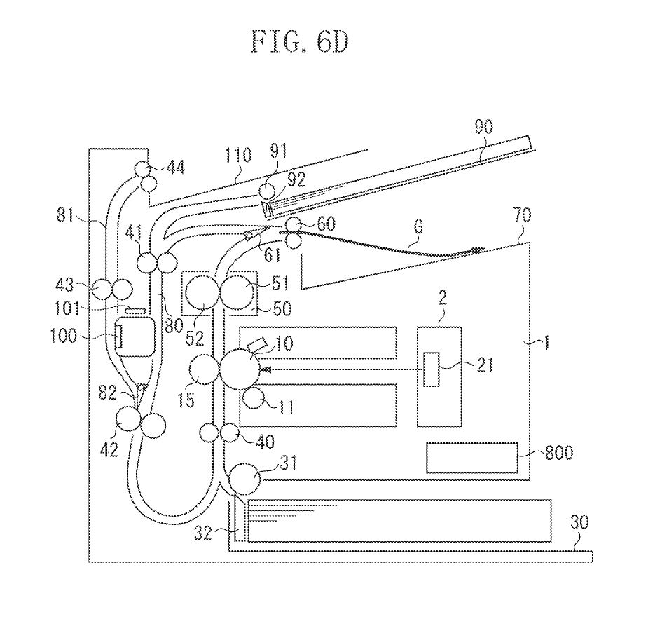

Next, an operation performed during overwriting printing is described. First, with reference to FIGS. 6A through 6D, operations performed when overwriting printing is performed on a first side (one side) of a document G are described. As similar to the operations described with reference to FIGS. 3A through 3E, first, a first side of the document G stored in the second sheet feeding unit 90 is read as illustrated in FIG. 6A. In a state illustrated in FIG. 6B, after the first side of the document G is read, the document G stops in a state of being pinched by the conveyance rollers 42. Then, in a state illustrated in FIG. 6C, the document G is conveyed to the conveyance rollers 40. The conveyance rollers 40 convey the document G toward the transfer unit 15 such that a toner image developed on the surface of the photosensitive drum 10 and a leading edge position of the document G reach the transfer unit 15 at the same timing. Accordingly, an image is formed on the first side of the document G as similar to that on the recording material S described with reference to FIG. 1. In other words, the overwriting printing is performed on the image on the first side of the document G. In a state illustrated FIG. 6D, after the image is formed on the document G, the document G is conveyed to the discharge rollers 60 and stacked on the first sheet stacking unit 70.

### (Two-Sided Overwriting Printing Operation)

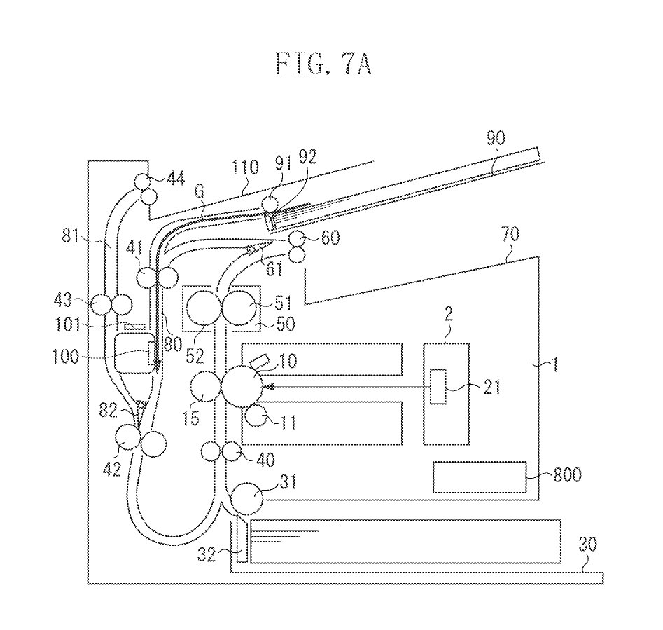

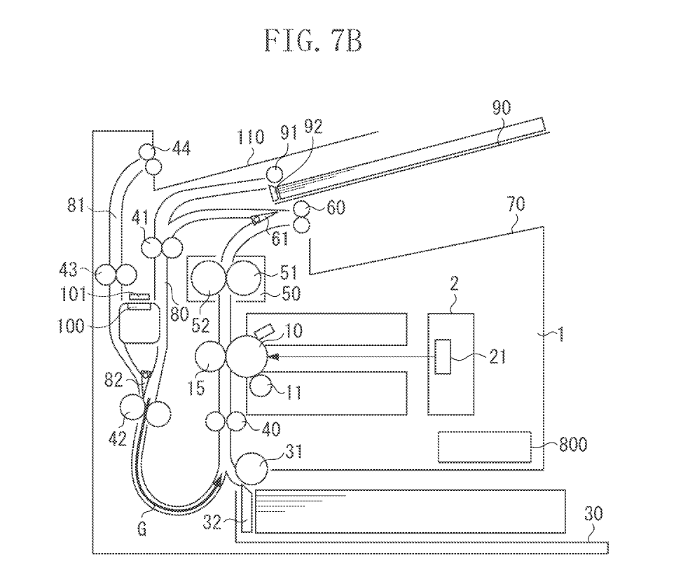

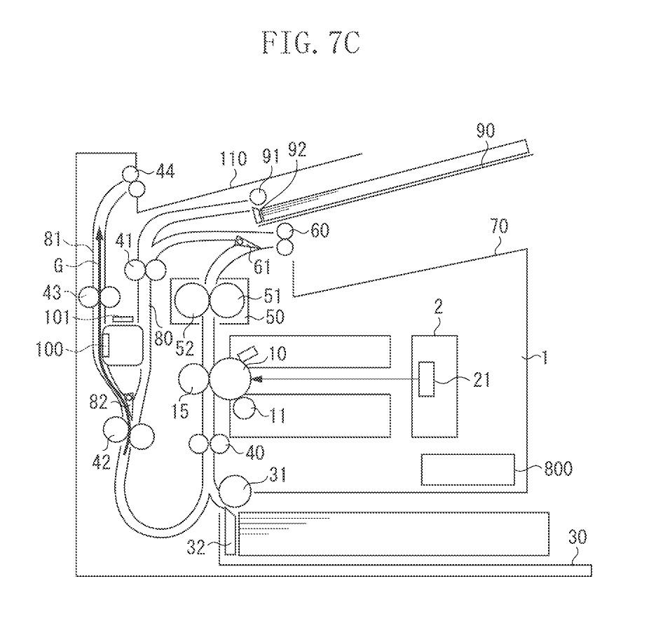

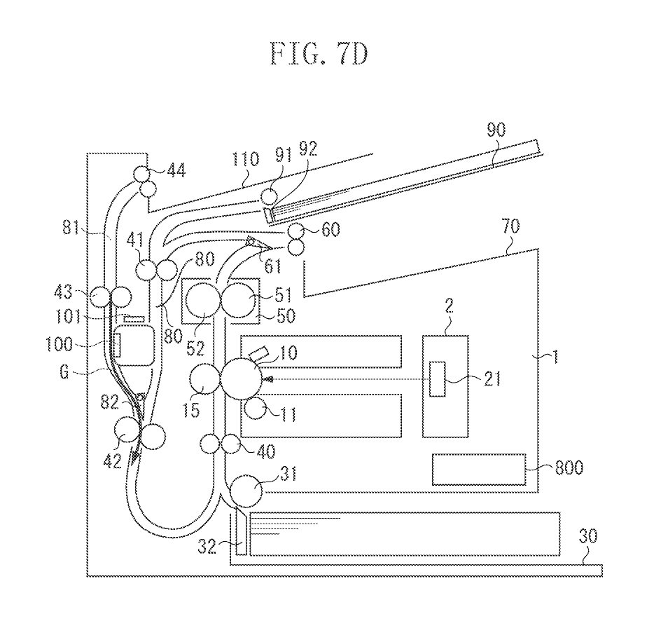

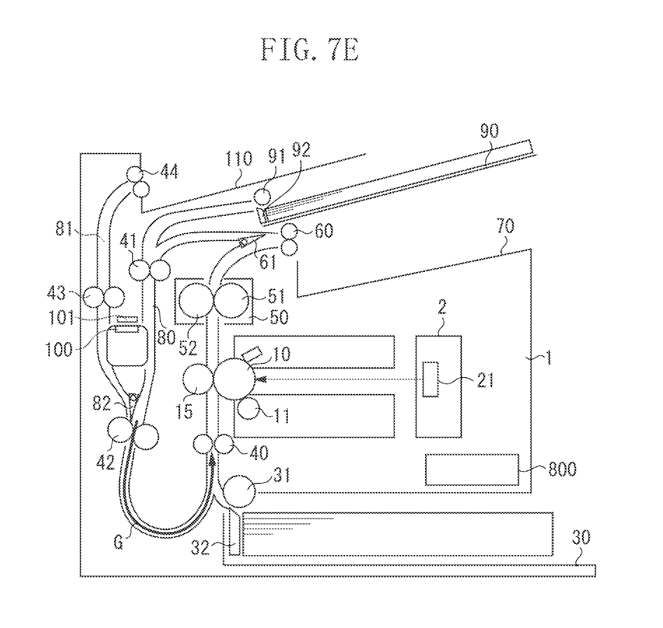

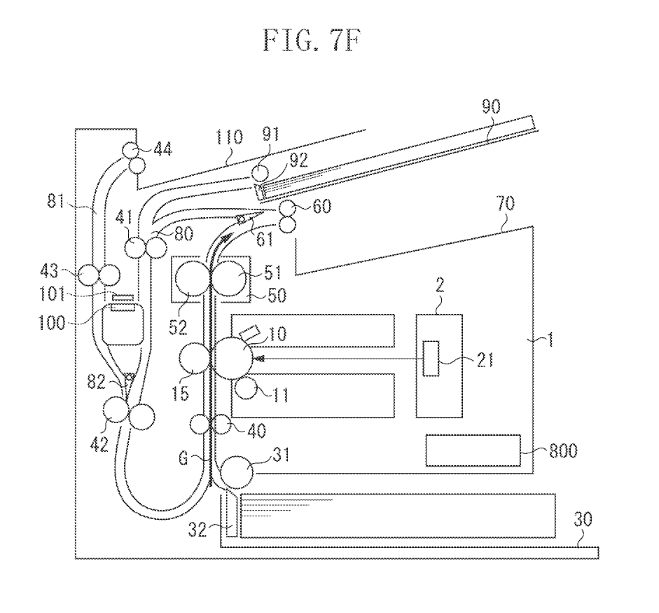

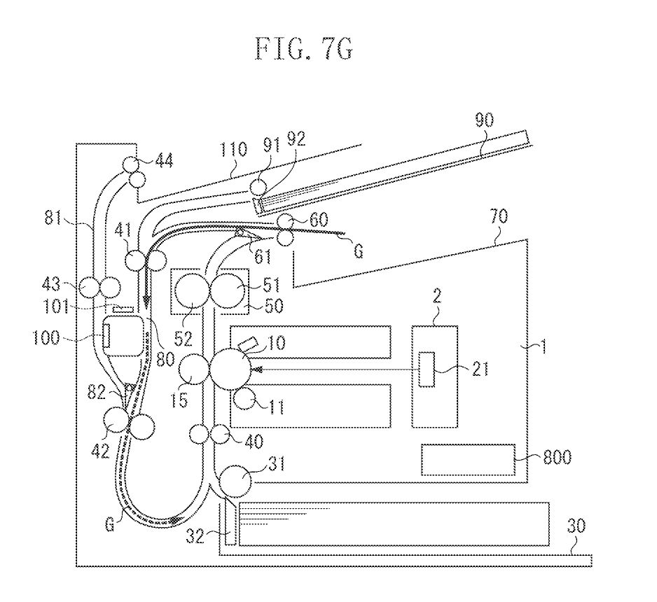

Next, a process for executing two-sided overwriting printing is described. The two-sided overwriting is executed in the following order. First, a first side and a second side of a document G are read, and then the document G is reversed. Secondly, overwriting printing is performed on the first side, and the document G is reversed. Lastly, overwriting printing is performed on the second side. FIGS. 7A through 7G illustrate a reading operation of a document G and an overwriting printing operation.

FIG. 7A illustrates a state in which a first side of the document G conveyed from the second sheet feeding unit 90 is read. After the first side is read, the document G is conveyed by the conveyance rollers 42. The conveyance of the document G pauses in a state illustrated in FIG. 7B, and then a conveyance direction of the document G is reversed. In a state illustrated in FIG. 7C, the second side of the reversed document G is read. Here, the document reading unit 100 is controlled to move a reading surface according to a conveyance state of the document G. More specifically, the reading surface of the document reading unit 100 faces toward the side of the two-sided conveyance path 80 in a state illustrated in FIG. 7A, whereas the reading surface faces toward the document-only conveyance path 81 in a state illustrated in FIG. 7C.

After the second surface of the document G is read, and the conveyance direction of the document G is reversed, the document G is conveyed again in the conveyance path 81 in an opposite direction as illustrated in FIG. 7D. At that time, the document reading unit 100 detects an end portion (a leading edge or a trailing edge) of the document G to pass therethrough. Thus, the document reading unit 100 can adjust the timing at which an image is formed on the photosensitive drum 10 based on the detected timing so that a toner image formed on the photosensitive drum 10 is transferred to an appropriate position of the document G to be conveyed to the transfer unit 15. Therefore, when the image formation is performed according to the detected timing of the edge of the document G, document displacement generated during conveyance of the document to the image forming unit or caused by a switchback operation subsequent to document reading can be accurately corrected.

Next, the document G is conveyed to the transfer unit 15 as illustrated in FIG. 7E, and the overwriting printing is executed on the first side of the document G as illustrated in FIG. 7F. Subsequently, the document G which is subjected to the overwriting printing on the first side thereof is reversed and conveyed as illustrated in FIG. 7G, and the overwriting printing is executed on the second side of the document G. Accordingly, the overwriting printing can be performed on both sides of the document G.

For performing the above-described operations, upon receipt of an overwriting printing command from the computer 850, the CPU 801 drives the two-sided flapper solenoid 820 and the two-sided drive motor 840, and operates a document feeding solenoid 823 to transmit torque of the two-sided drive motor 840 to the pick-up roller 91, so that the document G is conveyed. The CPU 801 stores the document image data read from the document reading unit 100 via the ASIC 802 by various types of control into the image memory 804 connected to the ASIC 802. In the case of the one-sided overwriting printing, the document G is stopped in a state of being pinched by the conveyance rollers 42. In the case of the two-sided overwriting printing, the document G is stopped in a state of being pinched by the conveyance rollers 43. The CPU 801 transmits the stored image data of the document G to the computer 850 via the external IF 805. The computer 850 generates image data for overwriting based on the document image data. Subsequently, the computer 850 notifies the CPU 801 of completion of the overwriting image generation, and transmits the overwriting image data.

Upon receipt of the notification of the overwriting image generation completion from the computer 850, the CPU 801 drives the main motor 830 and the two-sided drive motor 840 to convey the document G. The document G is conveyed to the transfer unit 15, and an image is formed on the first side thereof as described above. In the case of the two-sided overwriting printing, an image is also formed on the second side of the document G.

According to the above-described operations, an image printed on the document G is read, and an overwriting image is generated based on the read image. Consequently, the overwriting printing can be performed on the document G. Since the document conveyance path 81 and the recording material conveyance path 80 are shared, a reading operation and an overwriting operation of the document G can be automatically executed inside the image forming apparatus 1.

### [Image Processing Operation]

When an overwriting printing operation is performed on a document G, a new image is formed on the document G on which an image has already been formed. In a general image forming apparatus employing an electrophotographic method, an image is converted into a halftone image by performing dither processing as the AM screen processing as described above. Moreover, in general, since image processing is often performed using the dither processing, execution of overwriting printing on a portion of the document G with a printed image may cause moire on the image by interference between the image on the document G (dither processing) and an image to be used for overwriting printing (dither processing).

According to the present exemplary embodiment, when an overwriting printing operation is executed on a document G, the image processing apparatus 857 within the computer 850 changes halftone processing to be performed on an overwriting image to processing different from the dither processing.

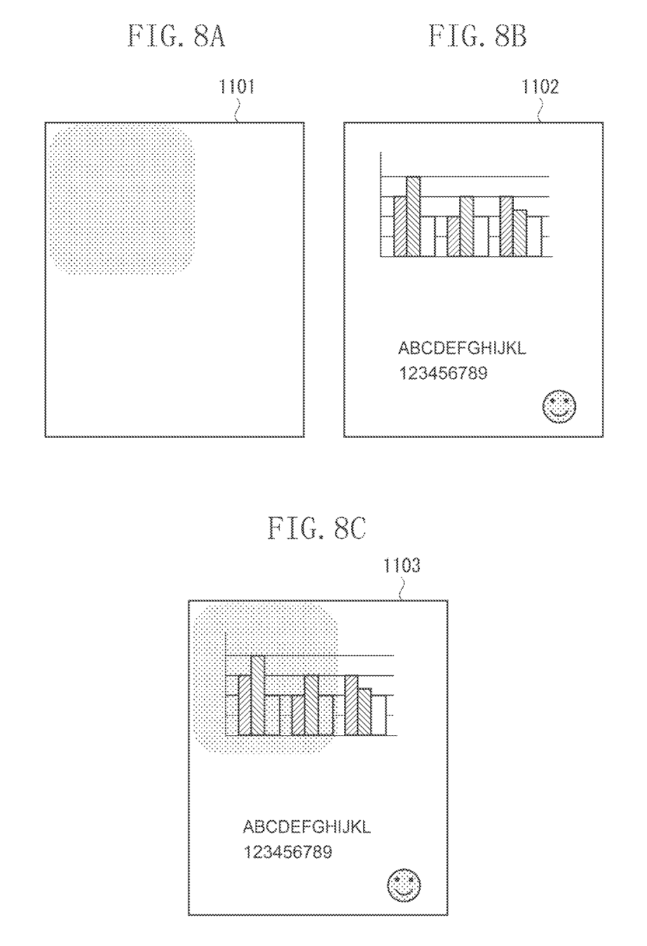

FIGS. 8A, 8B, and 8C illustrate examples of a document, an overwriting image, and an overwritten image printed on the document, respectively. FIG. 8A illustrates a document G with gradation expressed by dither processing. An area 1101 has undergone halftone processing by the dither processing, and has a predetermined periodic pattern image. FIG. 8B illustrates an overwriting image 1102 to overwrite the document G. According to the present exemplary embodiment, error diffusion processing as FM screen processing is performed on the overwriting image 1102. FIG. 8C illustrates an overwritten document G obtained by overwriting and printing the overwriting image 1102 illustrated in FIG. 8B on the document G illustrated in FIG. 8A. Since the overwriting image is converted into the halftone image by the error diffusion processing, there is not interference between the image data of the document G and the overwriting image 1102. Consequently, moire is not generated.

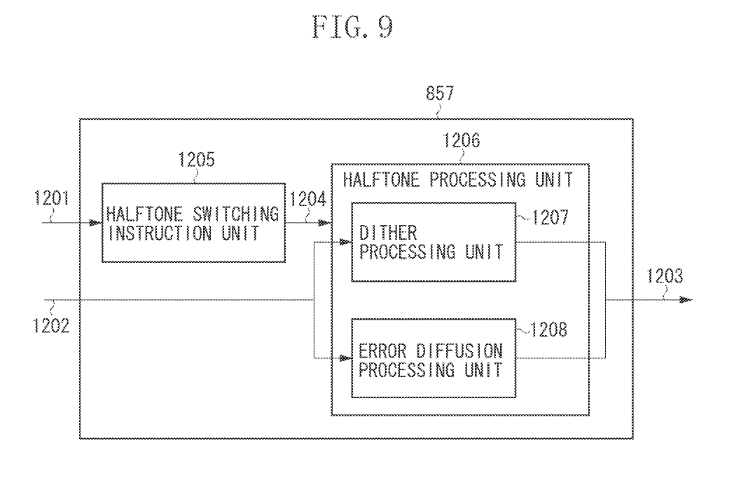

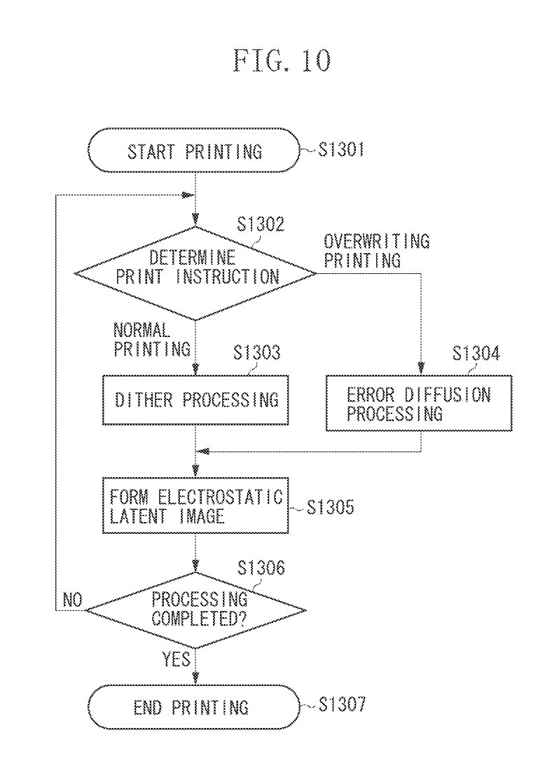

An image processing operation of the present exemplary embodiment is described with reference to FIGS. 9 and 10. FIG. 9 is a functional block diagram illustrating the image processing apparatus 857 installed in the computer 850. The image processing apparatus 857 includes a halftone switching instruction unit 1205 and a halftone processing unit 1206. The halftone processing unit 1206 includes a dither processing unit 1207 and an error diffusion processing unit 1208. FIG. 10 is a flowchart of an image processing operation performed by the image processing apparatus 857 according to the present exemplary embodiment.

In step S1301, the computer 850 receives a print instruction 1201 from the input/output apparatus 856. In step S1302, the image processing apparatus 857 causes the halftone switching instruction unit 1205 to determine whether the received print instruction 1201 is a normal print instruction or an overwriting printing instruction. The halftone switching instruction unit 1205 transmits a halftone switching signal 1204 as a determination result to the halftone processing unit 1206.

If the halftone switching instruction unit 1205 determines that the print instruction 1201 is a print instruction (normal printing in step S1302), the operation proceeds to step S1303. In step S1303, image data 1202 is transmitted to the dither processing unit 1207 of the halftone processing unit 1206, and dither processing is executed on the image data 1202. If the halftone switching instruction unit 1205 determines that the print instruction 1201 is an overwriting printing instruction (overwriting printing in step S1302), the operation proceeds to step S1304. In step S1304, the image data 1202 is transmitted to the error diffusion processing unit 1208 of the halftone processing unit 1206, and error diffusion processing is executed on the image data 1202.

The halftone processing unit 1206 performs halftone processing on the image data 1202 to generate image data 1203, and the image data 1203 is stored in the image memory 854 and the external storage apparatus 855. In step S1305, the image data 1203 is transmitted from the computer 850 to the light emitting unit 21 via the CPU 801 as a driving signal to the photosensitive drum 10 for emitting a laser beam, and is formed as an electrostatic latent image on the photosensitive drum 10. In step S1306, the computer 850 repeats the above-described operations until the halftone processing is completed to all of the image data pieces 1202 of overwriting targets. In step S1307, when all the image data pieces 1202 are processed, the print operation ends.

According to the present exemplary embodiment, the halftone processing unit is changed to the error diffusion processing unit in the case of the overwriting printing. However, the halftone processing is not limited to the error diffusion processing. For example, a method such as blue-noise mask of a frequency modulation method may be employed as the method different from dither processing.

According to the present exemplary embodiment, the image processing apparatus 857 is installed in the computer 850. However, the image processing apparatus 857 may be installed inside the image forming apparatus 1. For example, the CPU 801 inside the apparatus control unit 800 may execute image processing. Moreover, all of or a part of image processing may be executed by the ASIC 802.

As described above, the present exemplary embodiment can suppress generation of moire caused by interference of images when overwriting printing is executed on a document on which an image is already formed. Consequently, image quality can be maintained even when overwriting printing is executed.

According to the first exemplary embodiment, when overwriting printing is executed, error diffusion processing is performed on overwriting image data as halftone processing different from that performed on image data of a document G (dither processing). Such halftone processing suppresses moire caused by interference between an image of the document G and an image to be overwriting and printed on the document G.

According to a second exemplary embodiment, error diffusion processing is performed on an area in which an image of a document G overlaps an image to be overwritten. Configurations and operations of an image forming apparatus according to the present exemplary embodiment corresponding to FIGS. 1 through 7 are similar to those in the first exemplary embodiment, thus the descriptions thereof are omitted.

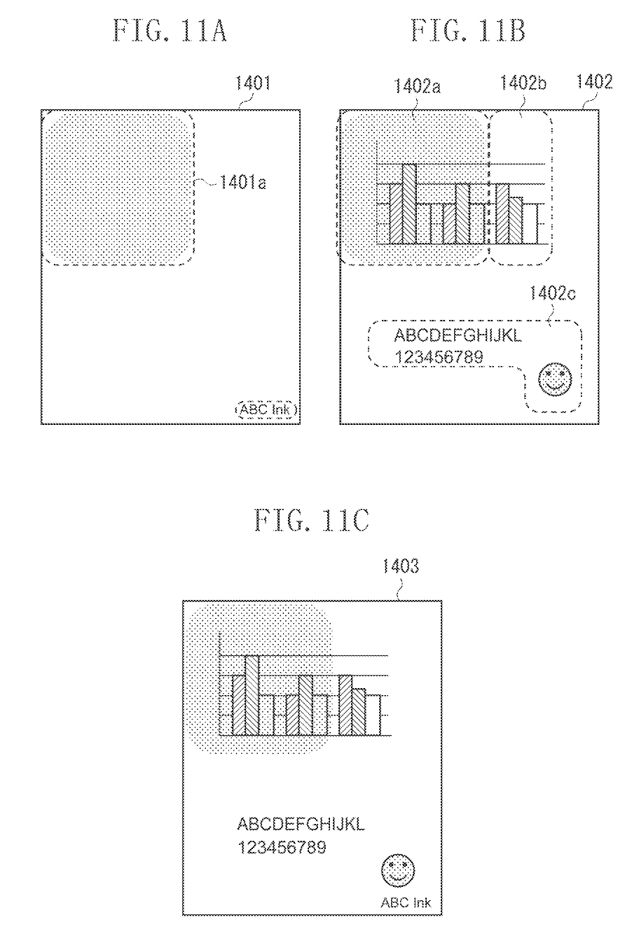

FIGS. 11A, 11B, and 11C illustrate examples of a document, an overwriting image, and an overwritten image printed on the document, respectively. FIG. 11A illustrates a document G with gradation expressed by dither processing. An entire area 1401 of the document G has undergone halftone processing by the dither processing, and has a predetermined periodic pattern. FIG. 11B illustrates an overwriting image to overwrite the document G. According to the present exemplary embodiment, error diffusion processing is performed on overwriting image data to be printed on an area 1401a in the document G illustrated in FIG. 11A. More specifically, in FIG. 11B, the error diffusion processing is executed on an area 1402a out of an entire area 1402 of the overwriting image. The dither processing is executed on other areas such as an area 1402b and an area 1402c. FIG. 11C illustrates an overwritten document G obtained by overwriting and printing the overwriting image illustrated in FIG. 11B on the document G illustrated in FIG. 11 in an entire area 1403. The halftone processing is executed by the error diffusion processing on overwriting image data 1202 to be printed in an area where the document G overlaps the overwriting image. Such halftone processing can suppress generation of moire. As for an area where moire is not generated, since the halftone processing by the dither processing is executed as similar to that executed on the document G, there is an advantage of reducing fluctuation of image quality in the overwritten document G obtained by overwriting printing.

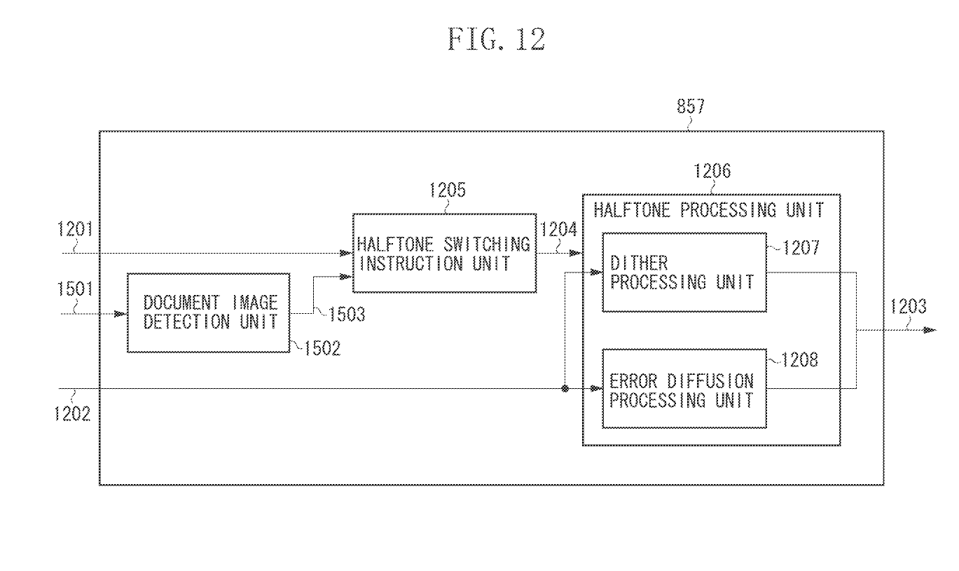

Next, an image processing operation according to the present exemplary embodiment is described with reference to FIG. 12. FIG. 12 is a block diagram illustrating an image processing apparatus 857 installed in a computer 850. Functional blocks similar to those described in the first exemplary embodiment are given the same reference numerals as above and descriptions thereof are omitted. According to the present exemplary embodiment, halftone processing is switched according to a print instruction data 1201 and a document image detection result 1503 by a document image detection unit 1502. According to the present exemplary embodiment, in a case where the print instruction data 1201 is an overwriting printing instruction and the document image detection result 1503 determines that image data is present in a document G, the error diffusion processing is executed on overwriting image data 1202 by an error diffusion processing unit 1208. The document image detection unit 1502 successively receives inputs of document image data 1501 obtained by reading the document G, and detects the presence or absence of image data on a pixel basis. The computer 850 causes the error diffusion processing unit 1208 to execute the error diffusion processing on the overwriting image data 1202 to overwrite the area 1402a where the image data is present in the document G according to the document image detection result 1503.

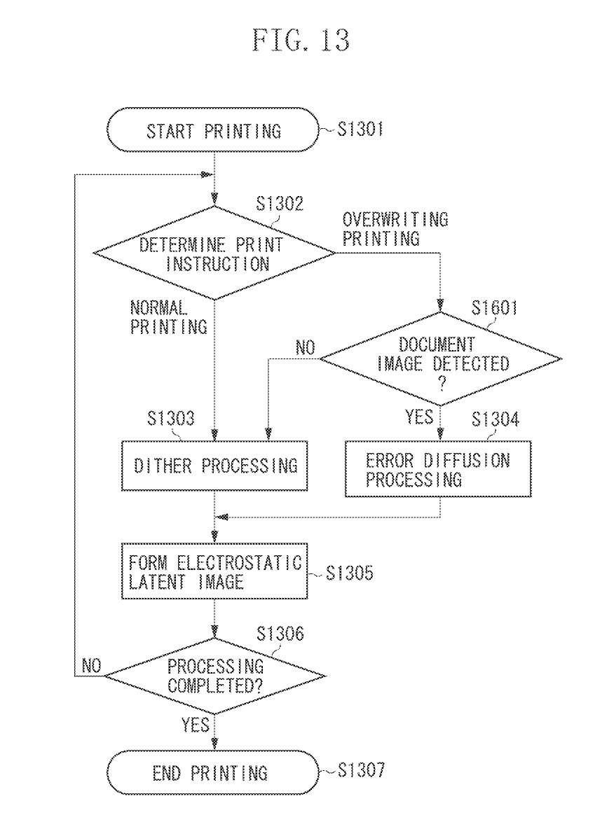

Next, an operation flow of the present exemplary embodiment is described with reference to FIG. 13. In step S1301, the computer 850 receives a print instruction 1201 from an input/output apparatus 856. In step S1302, the image processing apparatus 857 determines whether the print instruction 1201 is a normal print instruction or an overwriting printing instruction. If the print instruction 1201 is the overwriting printing instruction (overwriting printing in step S1302), then in step S1601, the document image detection unit 1502 determines whether image data is detected on a document G. If the document image detection unit 1502 determines that there is the image data on the document G (YES in step S1601), then in step S1304, the error diffusion processing is executed on the overwriting image data 1202.

If the print instruction 1201 is the normal print instruction (normal printing in step S1302), or if the print instruction 1201 is the overwriting printing instruction (overwriting printing in step S1302), and the image data is not detected on the document G (NO in step

S1601), the operation proceeds to step S1303. In step S1303, the dither processing is performed on the overwriting image data 1202.

Image data 1203 subjected to the halftone processing is stored in an image memory 854 and an external storage apparatus 855. Subsequently, in step S1305, the image data 1203 is transmitted from the computer 850 to a light emitting unit 21 via a CPU 801 as a driving signal to a photosensitive drum 10 for emitting a laser beam, and is formed as an electrostatic latent image on the photosensitive drum 10. In step S1306, the computer 850 repeats the above-described operations until the halftone processing is completed to all of the image data pieces 1202 to be overwritten. In step S1307, when all the image data pieces 1202 are processed, the print operation ends.

Next, an image detection method of the document image detection unit 1502 is described. The document image detection unit 1502 successively receives inputs of image data 1501 of the document G. The document image detection unit 1502 compares the document image data 1501 with a threshold value on a pixel basis, and detects the presence or absence of an image on a pixel basis. In other words, the document image detection unit 1502 has a function of binarizing the image data 1501 of the document G. One example of a binarization method is described below.

For example, it is assumed that the document image data 1501 is a color image (red, green, and blue RGB) and has a data width of 8 bits, and a threshold value is set to (TH_R, TH_G, TH_B)=(220, 220, 220), where 0 is black and 255 is white. If a value is larger than the threshold value, the document image detection unit 1502 detects that the image is white. If a value is smaller than the threshold value, the document image detection unit 1502 detects that the image is black. In such a case, if any one of the RGB color values is below the threshold value, the document image detection unit 1502 detects that there is image data. For example, if the RGB values are (R, G, B)=(255, 200, 250), the document image detection unit 1502 detects that there is an image (pixel). If the RGB values are (R, G, B)=(240, 245, 240), the document image detection unit 1502 detects that there is no image (pixel).

Although the RGB color image is described as an example of the document image data 1501, a Lab color image, or a monochrome image obtained by converting a color image may be used. The error diffusion processing unit 1208 executes the error diffusion processing on the pixel determined as the presence of an image therein. On the other hand, the dither processing unit 1207 executes the dither processing on the pixel determined as the absence of an image therein. According to the present exemplary embodiment, the document image data and the threshold value are compared to detect the presence or absence of the image data 1501 of the document G. However, the present exemplary embodiment is not limited to this method. Alternatively, other methods may be used.

For example, the presence or absence of the image data 1501 of the document G may be detected based on information which is obtained by detecting and classifying attribute information of an image indicating whether the image is a character, a photograph, or graphics at the time of reading. Moreover, a frequency of the image data 1501 of the document G may be analyzed using a matrix having pixels of N×N (where N is an integer of 1 or greater), so that an image having a frequency liable to cause interference may be detected as the presence of the image data of the document G.

As described above, according to the present exemplary embodiment, when overwriting printing is executed, error diffusion processing is performed on an area in which an image of a document and an overwriting printing image overlap. Accordingly, moire in the overwritten area can be suppressed. Moreover, dither processing is performed on image data of an area in which an image of the document G is not overlapped, so that image quality of the entire document can be maintained.

According to the second exemplary embodiment, error diffusion processing is performed on an overwriting image of an area in which an image of a document G overlaps the overwriting image. Such processing suppresses moire caused by the interference between the image of the document G and the overwriting image. According to a third exemplary embodiment, overwriting image data 1202 for overwriting printing is recognized in an object basis. If a portion of pixels within the recognized object is to overlap an image of the document G, error diffusion processing is performed on the object. In a case where two different types of processing (dither processing and error diffusion processing) are performed within one object, there is a possibility that a difference in image quality is visually recognized on the border of the two processing. Thus, halftone processing is performed on an object basis according to the present exemplary embodiment. In other words, the present exemplary embodiment can reduce an image quality difference caused by switching the halftone processing within one object.

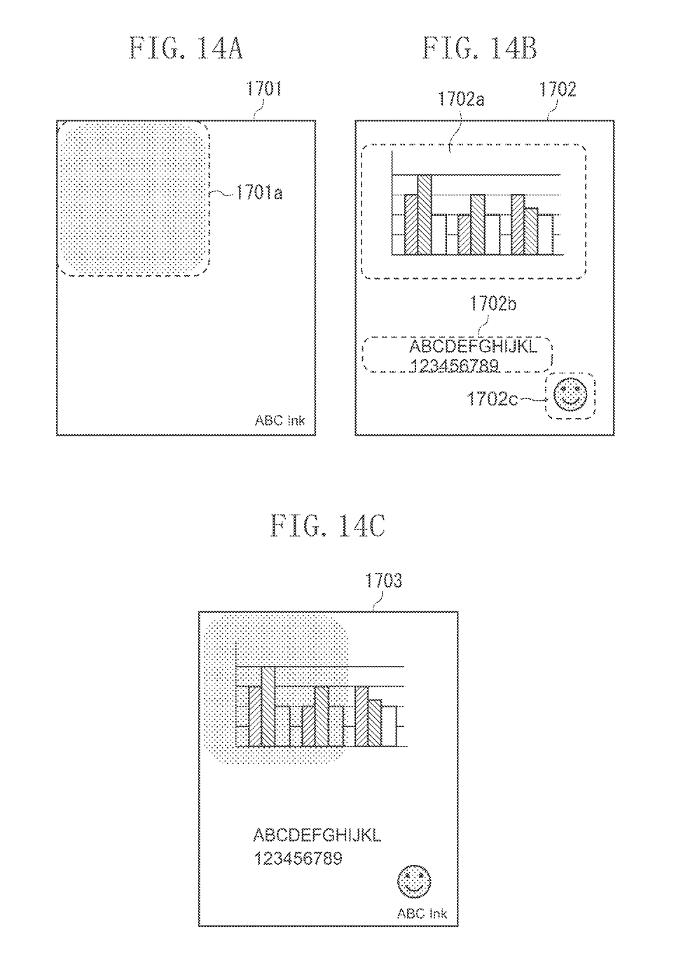

FIGS. 14A, 14B, and 14C illustrate examples of a document, an overwriting image, and an overwritten document, respectively. FIG. 14A illustrates a document G with gradation expressed by dither processing. An area 1701 of the document G has undergone halftone processing by the dither processing, and has a predetermined periodic pattern. FIG. 14B illustrates an overwriting image to overwrite the document G. The error diffusion processing is performed on image data in an area 1702a out of an area 1702 illustrated in FIG. 14B. The image data in the area 1702 is to be overwritten on an area 1701a illustrated in FIG. 14A. The dither processing is performed on other areas such as areas 1702b and 1702c illustrated in FIG. 14B. FIG. 14C illustrates an overwritten document G with an area 1703. The overwritten document G is obtained by printing the overwriting image illustrated in FIG. 14B on the document G illustrated in FIG. 14A. The overwriting image is divided into a plurality of objects. If image data of the document G overlaps any of the divided objects, the error diffusion processing is performed on an object basis, so that image quality differences within the object can be suppressed while suppressing moire generation.

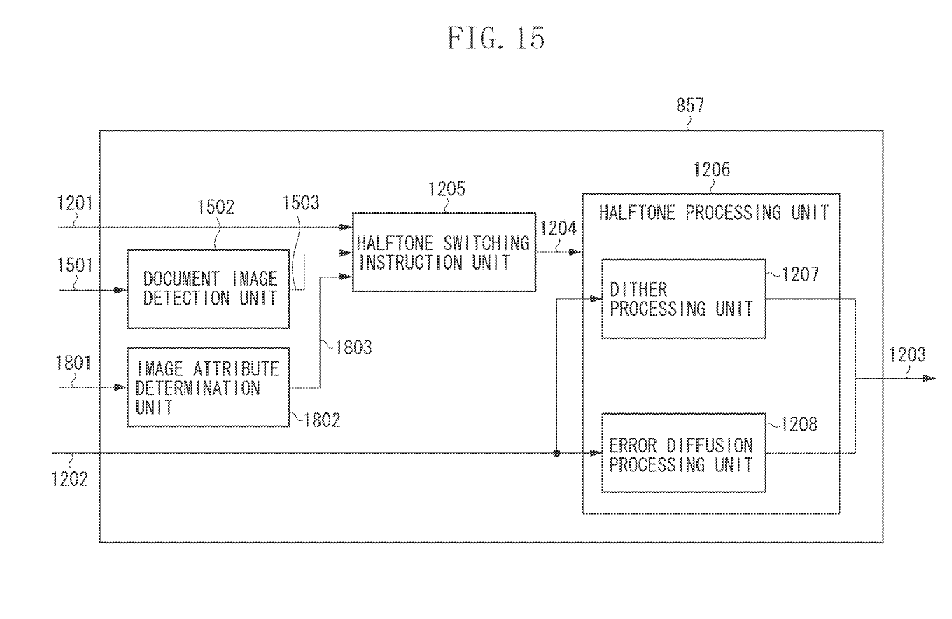

FIG. 15 is a block diagram illustrating an image processing apparatus 857 installed in a computer 850 according to the present exemplary embodiment. According to the present exemplary embodiment, halftone processing is switched according to print instruction data 1201, a document image detection result 1503 by a document image detection unit 1502, and an image attribute determination result 1803 by an image attribute determination unit 1802. In FIG. 15, components and configurations similar to those described in the first and second exemplary embodiments are given the same reference numerals as above and description thereof are omitted. When the image attribute determination unit 1802 receives overwriting image data 1801 generated in the computer 850, the image attribute determination unit 1802 divides the overwriting image data 1801 on an object basis, and determines whether each of the divided objects overlaps an image of the document G. For example, the overwriting image data is divided into objects, like 1702a, 1702b, and 1702c as illustrated in FIG. 14B, with use of image attribute information output from the computer 850. The area 1701a illustrated in FIG. 14A included in the area 1702a in the overwriting image data illustrated in FIG. 14B, Accordingly, the error diffusion processing is performed on the area 1702a by an error diffusion processing unit 1208.

According to the present exemplary embodiment, in a case where the print instruction data 1201 is an overwriting printing instruction, the image attribute determination result 1803 of the image attribute determination unit 1802 indicates the object, and the document image detection result 1503 of the document image detection unit 1502 detects that image data is present in the document G in the object, the error diffusion processing unit 1208 executes the error diffusion processing on the overwriting image data 1202 on an object basis.

Next, an image attribute determination method of the image attribute determination unit 1802 is described. The image attribute determination unit 1802 divides the overwriting image data illustrated in FIG. 14B into three objects (attribute information) of the graphic portion 1702a, the text portion 1702b, and the graphic portion 1702c using the image attribute information output from the computer 850. The image attribute determination unit 1802 further provides object information to each of the divided objects.

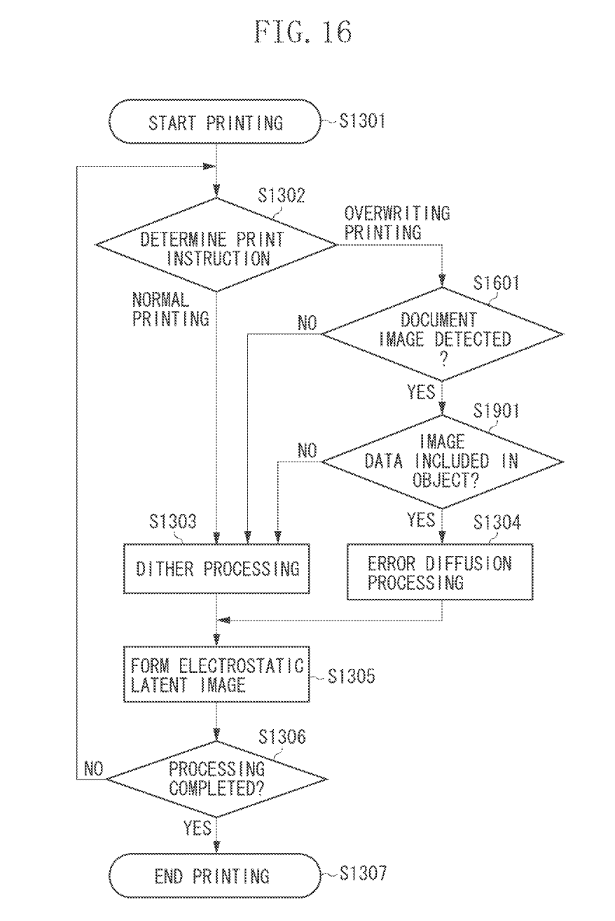

Next, an image processing operation according to the present exemplary embodiment is described with the flowchart illustrated in FIG. 16. In step S1301, the computer 850 receives the print instruction 1201 from an input/output apparatus 856. In step S1302, the image processing apparatus 857 determines whether the print instruction 1201 is an overwriting printing instruction or a normal print instruction. If the print instruction 1201 is the overwriting printing instruction (overwriting printing in step S1302), then in step S1601, the document image detection unit 1502 determines whether image data is detected on a document G.

If the document image detection result 1503 of the document image detection unit 1502 indicates that there is the image data (YES in step S1601), the operation proceeds to step S1901. In step S1901, the image attribute determination unit 1802 divides the image data on the overwriting image data 1801 into objects, and the image processing apparatus 857 determines whether the document image detection result 1503 indicates that there is the image data in each of the objects divided by the image attribute determination unit 1802. If the document image detection result 1503 indicates the presence of the image data on the document G (YES in step S1901), then in step S1304, the error diffusion processing unit 1208 executes the error diffusion processing on the object within the overwriting image data.

On the other hand, if the object of the overwriting image data 1202 is determined that there is no image data in the document G (NO in step S1601) (or the print instruction 1201 is normal printing in step S1302), then in step S1303, the dither processing unit 1207 performs the dither processing on all the image data pieces 1202.

Image data 1203 subjected to the halftone processing is stored in an image memory 854 and an external storage apparatus 855. In step S1305, the image data 1203 is transmitted from the computer 850 to a light emitting unit 21 via a CPU 801 as a driving signal to a photosensitive drum 10 for emitting a laser beam, and is formed as an electrostatic latent image on the photosensitive drum 10. In step S1306, the computer 850 repeats the above-described operations until the halftone processing is completed to all of the image data pieces 1202 to be overwritten. In step S1307, when all the image data pieces 1202 are processed, the print operation ends.

As described above, according to the present exemplary embodiment, when image data of a document overlaps one of objects of overwriting image data, the same halftone processing is performed across the one object. Such halftone processing can suppress an image quality difference within the one object and moire caused by interference between the image data of the document and the overwriting image data. Moreover, dither processing is performed on overwriting image data in an area in which the image of the document is not overlapped, so that image quality of the entire document can be maintained.

According to the first through third exemplary embodiments, a configuration of an image forming apparatus forming a monochrome image is described. However, the exemplary embodiments of the present invention can be applied to a color image forming apparatus. For example, the exemplary embodiments can be applied to a color image forming apparatus employing a transfer method in which four photosensitive drums serving as image bearing members for forming respective color images of yellow, magenta, cyan, and black are arranged, and the color images are transferred on a recording material in an overlapping manner from the respective photosensitive drums. Further, the exemplary embodiments can be applied to a color image forming apparatus employing a secondary transfer method by which images are primarily transferred on an intermediate transfer member in an overlapping manner from the respective photosensitive drums, and then the transferred color image is secondarily transferred to a recording material. Furthermore, the exemplary embodiments can be applied to a color image forming apparatus employing a method for sequentially forming each image of yellow, magenta, cyan, and black on one image bearing member (a photosensitive drum), transferring the images onto an intermediate transfer member in an overlapping manner, and transferring the color image formed on the intermediate transfer member to a recording material.

Moreover, the effects of the above-described exemplary embodiments can be achieved as follows. A storage medium storing software or a program for realizing the functions described in the first through third exemplary embodiments is supplied to a system or an apparatus, so that the system or a computer (or a CPU or a micro-processing unit (MPU)) of the apparatus can read and execute a program code stored in the storage medium. In this case, the program itself read from the storage medium, or the storage medium storing the program code can realize the functions of the above-described exemplary embodiments. The storage medium for supplying the program code can include, for example, a flexible disk, a hard disk, an optical disk, a magneto-optical disk, a compact disc read-only memory (CD-ROM), a CD-recordable (CD-R), a magnetic tape, a non-volatile memory card, a read only memory (ROM), and a digital versatile disk (DVD).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-105896 filed May 7, 2012, which is hereby incorporated by reference herein in its entirety.

What is claimed is:

1. An image forming apparatus comprising:
a reading unit configured to read an image of a document; and
a control unit configured to switch image processing with respect to an overwriting image to overwrite the document based on the read image of the document,
wherein the control unit switches image processing of the overwriting image to image processing different from image processing with respect to the image of the document.

2. The image forming apparatus according to claim 1, wherein, in an area in which the image of the document and the overwriting image overlap, the control unit switches image processing of the overwriting image to image processing different from image processing with respect to the image of the document.

3. The image forming apparatus according to claim 1, wherein the control unit detects attribute of the overwriting image and switches the image processing based on a detection result.

4. The image forming apparatus according to claim 1, wherein the image processing is to convert an image to a halftone image by amplitude modulation (AM) screen processing or frequency modulation (FM) screen processing.

5. The image forming apparatus according to claim 4, wherein the AM screen processing includes dither processing, and the FM screen processing includes error diffusion processing.

6. The image forming apparatus according to claim 1, wherein the image processing is switched according to an instruction from an outside.

7. The image forming apparatus according to claim 1, wherein the read image of the document is binarized to detect presence or absence of a pixel of the image of the document.

8. The image forming apparatus according to claim 1, wherein presence or absence of a pixel of the image of the document is detected based on a result of analysis of a frequency of the image of the document.

9. The image forming apparatus according to claim 1, wherein the overwriting image is analyzed and divided on an object basis to detect whether the divided object and the image of the document overlap, and in a case where the divided object and the image of the document overlap, image processing with respect to the object is switched to image processing different from image processing with respect to the image of the document.

10. A program for causing a computer to execute an operation of an image forming apparatus according to claim 1.

11. A computer-readable storage medium storing a program according to claim 10.

12. A method for image processing of an image forming apparatus, the method comprising:
overwriting an image on a document on which an image is recorded; and
performing image processing different from image processing with respect to the recorded image on the document in a case where image processing is performed on the overwriting image.

13. The method according to claim 12, further comprising switching image processing of the overwriting image, for an area in which the image of the document and the overwriting image overlap, to image processing different from image processing with respect to the image of the document.

14. The method according to claim 12, further comprising:
detecting attribute of the overwriting image; and
switching the image processing based on a detection result.

15. The method according to claim 12, wherein the image processing is to convert an image to a halftone image by AM screen processing or FM screen processing.

16. The method according to claim 12, further comprising detecting presence or absence of a pixel of the image of the document in a document by binarizing the read image of the document.

17. The method according to claim 12, further comprising:
analyzing a frequency of the image of the document; and
detecting presence or absence of a pixel of the image of the document in a document based on a result of the frequency analysis.

18. The method according to claim 12, further comprising:
analyzing the overwriting image to divide the overwriting image on an object basis;
detecting whether the divided object and the image of the document overlap; and
switching image processing with respect to the object to image processing different from image processing with respect to the image of the document if the divided object and the image of the document overlap.
